(19) United States
(12) Patent Application Publication
(10) Pub. No.: US 2018/0137274 A1
(43) Pub. Date: May 17, 2018

(54) MALWARE ANALYSIS METHOD AND STORAGE MEDIUM

(71) Applicant: Hitachi Solutions, Ltd., Tokyo (JP)

(72) Inventors: Hayato YOSHIDA, Tokyo (JP); Tateki HARADA, Tokyo (JP); Yuzo OSHIDA, Tokyo (JP); Takanori NASU, Tokyo (JP)

(21) Appl. No.: 15/806,887

(22) Filed: Nov. 8, 2017

(30) Foreign Application Priority Data
Nov. 17, 2016 (JP) 2016-223692

(51) Int. Cl. G06F 21/53; H04L 29/06

(52) U.S. Cl. CPC G06F 21/53; H04L 63/1416; H04L 63/145

(57) ABSTRACT

A malware analysis method for analyzing malware using a virtual computer includes acquiring a request from the malware to the guest OS. If the request from the malware includes a request pertaining to a virtual environment, an analysis unit issues a spoofed response to the malware in response to the request.

### CLAIM OF PRIORITY

The present application claims priority from Japanese patent application JP 2016-223692 filed on Nov. 17, 2016, the content of which is hereby incorporated by reference into this application.

### BACKGROUND

The present invention relates to a technique for monitoring malware, which penetrates a computer and performs a malicious operation.

With the spread of the internet, there are frequent attacks in which malware, which is malicious software or code, penetrates computers as a result of viewing spam emails or websites. In recent years, malware performs operations such as stealing information or locking/encrypting a computer or file and demanding ransom, on the basis of commands or the like from a command and control (C&C) server.

One known type of malware operates intermittently using sleep mode in order to avoid detection by security software or a dynamic analysis system that monitors malware. There are also types of malware that operate over long periods of time by the malware undergoing change itself or changing its attack method, such as by downloading and installing new malware or attacking another computer or website according to a command by an attacker using the C&C server.

In one known technique for analyzing the operation of malware, analysis is performed while the malware operates on a virtual machine (Patent Document 1 (JP 2014-211733 A), for example). In Patent Document 1, a plurality of pieces of malware operate on a virtual machine, and a system image is acquired by a snapshot function on the virtual machine, thereby enabling detection of change over time in the malware.

### SUMMARY

Recent types of malware have emerged in which, when the malware detects that it is operating in a virtual environment, it stops operating or deletes itself. As a result of such malware detecting the virtual environment and stopping operation, there were cases in which the dynamic analysis system falsely determines the malware to be harmless software.

The present invention takes into consideration the above problem, and an object thereof is to reliably monitor malware designed to stop operating or delete itself when it detects a virtual environment.

A representative aspect of the present disclosure is as follows. A malware analysis method for analyzing malware using a virtual computer operating on a physical computer including a processor and memory, the method comprising: a first step in which an analysis unit operating on a guest OS on the virtual computer acquires a request from the malware to the guest OS; and a second step in which, if the request from the malware includes a request pertaining to a virtual environment, the analysis unit issues a spoofed response to the malware in response to the request.

Therefore, according to the present invention, it is possible to cause malware to continue operating in a virtual environment despite being designed to stop operating or delete itself when it detects the virtual environment, and to monitor the malware.

### BRIEF DESCRIPTION OF THE DRAWINGS

FIG. 1 is a block diagram showing one example of a malware dynamic analysis system of an embodiment of the present invention.

FIG. 2 is a block diagram that schematically shows the malware dynamic analysis unit of the embodiment of the present invention.

FIG. 3 shows an example of a communication determination database of the embodiment of the present invention.

FIG. 4 shows an example of the whitelist of the embodiment of the present invention.

FIG. 5 shows an example of the spoofed response database of the embodiment of the present invention.

FIG. 6 is a flowchart showing one example of a process performed in a malware dynamic analysis system of the embodiment of the present invention.

FIG. 7 is a flowchart showing an example of the process performed in the response spoofing unit of the embodiment of the present invention.

FIG. 8 is a flowchart showing an example of the process performed in the communication spoofing unit of the embodiment of the present invention.

### DETAILED DESCRIPTION OF EMBODIMENTS

An embodiment of the present invention will be described below with reference to affixed drawings.

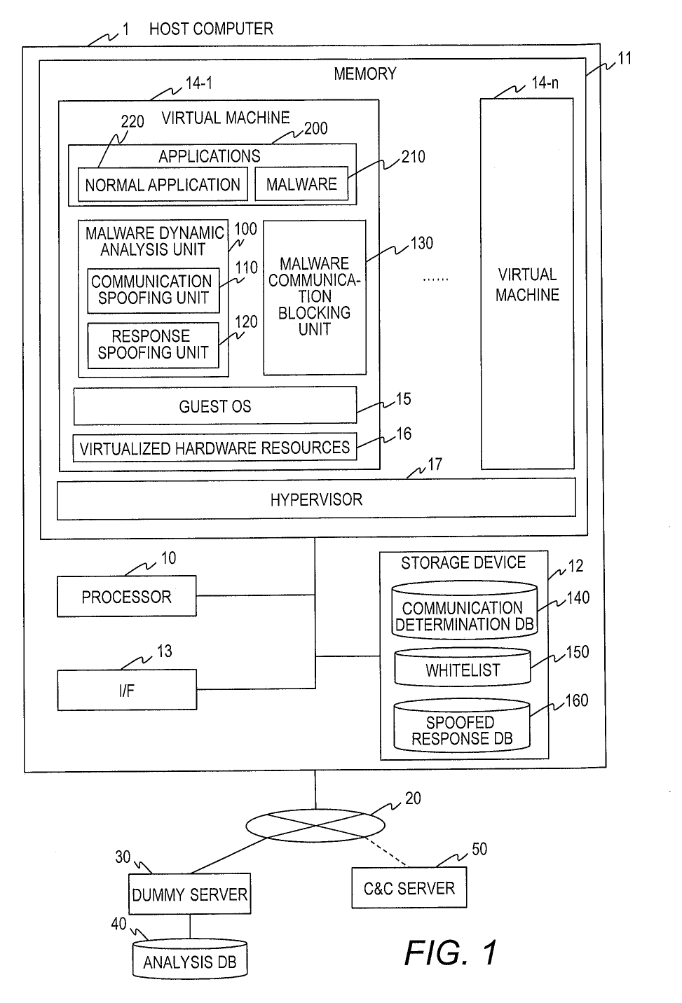

FIG. 1 is a block diagram showing one example of a malware dynamic analysis system of an embodiment of the present invention.

The malware dynamic analysis system includes a host computer 1 in which virtual machines 14-1 to 14-n that monitor the activity of malware operate, a dummy server 30 that spoofs the communication destination of the malware and collects communication content, and a network 20 that connects the host computer 1 to the dummy server 30. As will be described later, the connection of the malware to the C&C server 50, which is the intended communication destination of the malware, is severed.

The host computer 1 includes a processor 10 that performs operations, a memory 11 that retains programs and data, an interface 13 connected to the network 20, and a storage device 12 that stores data and programs.

The hardware of the host computer 1 is virtualized, and a hypervisor 17 that controls the virtual machines 14-1 to 14-n is loaded to the memory 11 and executed by the processor 10. When describing the virtual machines in general, the reference character “14”, which omits the hyphenated portion, is used.

In the virtual machine 14, a guest OS 15 operates on virtualized hardware resources 16 provided by the hypervisor 17. On the guest OS 15, a malware dynamic analysis unit 100, a malware communication blocking unit 130, and applications 200 operate. In the present embodiment, an example will be described in which a hypervisor is used as the software (virtualizing unit) that virtualizes (logicizes) hardware resources of the host computer 1, but a virtual machine monitor (VMM) may alternatively be used.

Among the applications 200 are normal applications 220 that are defined in a whitelist 150 to be described later, and malware 210 to be analyzed. In the present embodiment, the malware 210 is not defined in the whitelist 150, and is software that performs unauthorized communication with an external computer. An example of such an external computer is a C&C server 50.

In the virtual machine 14, which monitors the malware 210, the following components operate: the malware communication blocking unit 130, which suppresses attacks by the malware 210 on other virtual machines 14 and other host computers, which block communications from the malware 210 to the outside; and the malware dynamic analysis unit 100, which causes the malware 210 to operate in a virtual environment and monitors the malware.

The malware dynamic analysis unit 100 includes a response spoofing unit 120 that hooks a command from the malware 210 to the guest OS 15 and issues a spoofed response, and a communication spoofing unit 110 that spoofs communications between the malware 210 and the outside.

The respective functions of the communication spoofing unit 110 and the response spoofing unit 120 of the malware dynamic analysis unit 100, and the malware communication blocking unit 130 are loaded to the memory 11 as programs and executed by the processor 10.

The processor 10 operates as a functional unit that provides prescribed functions by executing processes according to programs in respective functional units. The processor 10 functions as the response spoofing unit 120 by performing processes according to a response spoofing program, for example. The same applies for other programs. Additionally, the processor 10 also operates as functional units providing, respectively, functions of a plurality of processes executed by respective programs. The computer and the computer system are a device and system including these functional units.

Programs, tables, and the like realizing respective functions of the malware dynamic analysis unit 100 can be stored in a storage device such as the storage device 12, a non-volatile semiconductor memory, a hard disk drive, or a solid-state drive (SSD), or in a computer-readable non-transitory data storage medium such as an IC card, an SD card, or a DVD.

The dummy server 30, in place of the C&C server 50, receives data transmitted by the malware 210 and accumulates the communication content in an analysis database 40. A user of the malware dynamic analysis system can analyze the communication content of the malware 210 by referring to the analysis database 40 of the dummy server 30.

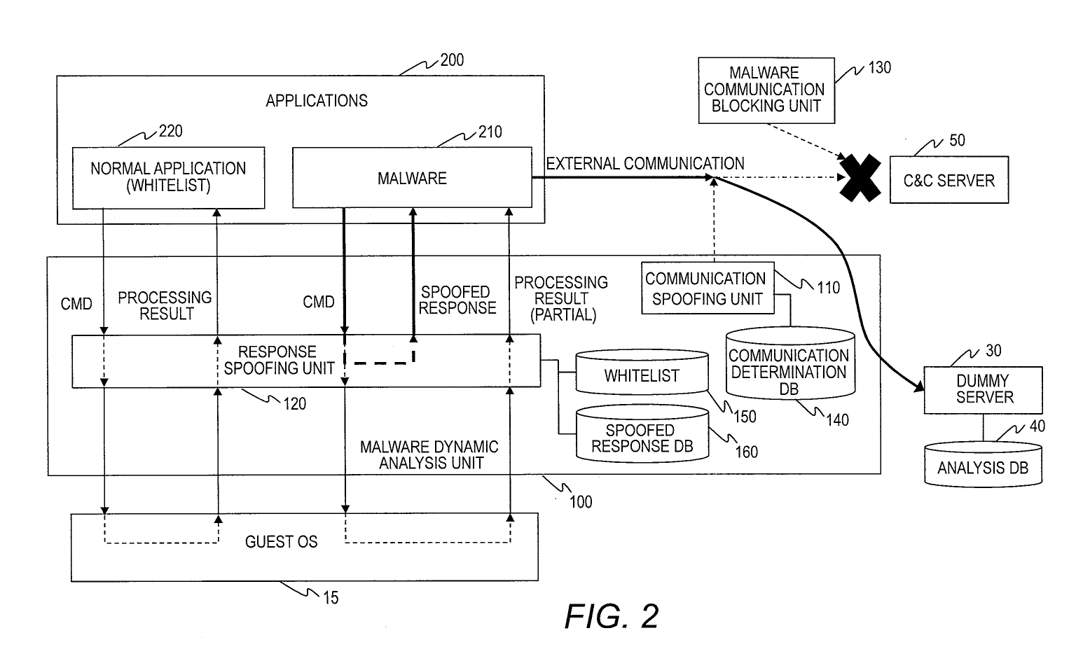

FIG. 2 is a block diagram that schematically shows the malware dynamic analysis unit 100. In the virtual machine 14, the malware communication blocking unit 130 and the malware dynamic analysis unit 100 are started up in advance, and then operation of the malware 210 subject to monitoring is started. In other words, the virtual machine 14 is infected with the malware 210.

The malware communication blocking unit 130 monitors the software executed by the processor 10, determines that any software not defined in the whitelist 150 is malware 210, identifies ports used by the malware 210, and blocks those ports. In this manner, the malware communication blocking unit 130 mitigates infection of other host computers and the virtual machine 14 by the malware 210 being monitored, and suppresses communications between the malware 210 and the C&C server 50.

Next, the malware communication blocking unit 130 notifies the malware dynamic analysis unit 100 of the port numbers used by the malware 210 for communication. The response spoofing unit 120 of the malware dynamic analysis unit 100 hooks requests (commands (CMD in the drawing) and operations) by the applications 200 to the guest OS 15, and among the applications 200, requests from the normal applications 220 are passed as is to the guest OS 15, and processes according to the requests are executed.

Regarding requests to the guest OS 15 by the malware 210 among the applications 200, the response spoofing unit 120 refers to a spoofed response database 160, and if there is a spoofed response defined for such requests, the response spoofing unit transmits the spoofed response to the malware 210 as described later, indicating that the malware is not operating in a virtual environment. In other words, when the guest OS 15 receives a request from the malware 210 regarding the virtual environment, the response spoofing unit 120 spoofs a response by issuing a response instead of the guest OS 15 including information indicating that no virtual environment is present.

In this manner, it is possible to cause the malware 210 to continue operating in a virtual environment despite being designed to stop operating or delete itself when it detects a virtual environment, and for the behavior of the malware to be monitored. The guest OS 15 may be configured to execute requests for which a spoofed response is not defined in the spoofed response database 160.

Similar to the malware communication blocking unit 130, when the response spoofing unit 120 hooks commands or operations from the application 200, it acquires the process name of the application 200, and if the process name is not defined in the whitelist 150, it determines that the request is coming from the malware 210.

Next, when the malware 210 communicates with the C&C server 50, the communication spoofing unit 110 issues a request to the malware communication blocking unit 130 for a port to be opened. The malware communication blocking unit 130 opens the port requested by the malware 210 for use.

The communication spoofing unit 110 spoofs the destination of packets sent by the malware 210 to an address of the dummy server 30 (dummy address) set in advance and performs communication. In this manner, the analysis database 40 of the dummy server 30 accumulates data transmitted by the malware 210 to the outside (C&C server 50). The communication spoofing unit 110 allows through packets as is for communication by the normal applications 220.

As described above, the response spoofing unit 120 performs spoofing such that the malware 210 believes that it is operating on a physical computer, and allows activities of the malware 210 to continue. By the communication spoofing unit 110 replacing the destination of packets from the malware 210 with the address of the dummy server 30, communication content of the malware 210 can be accumulated in the analysis database 40.

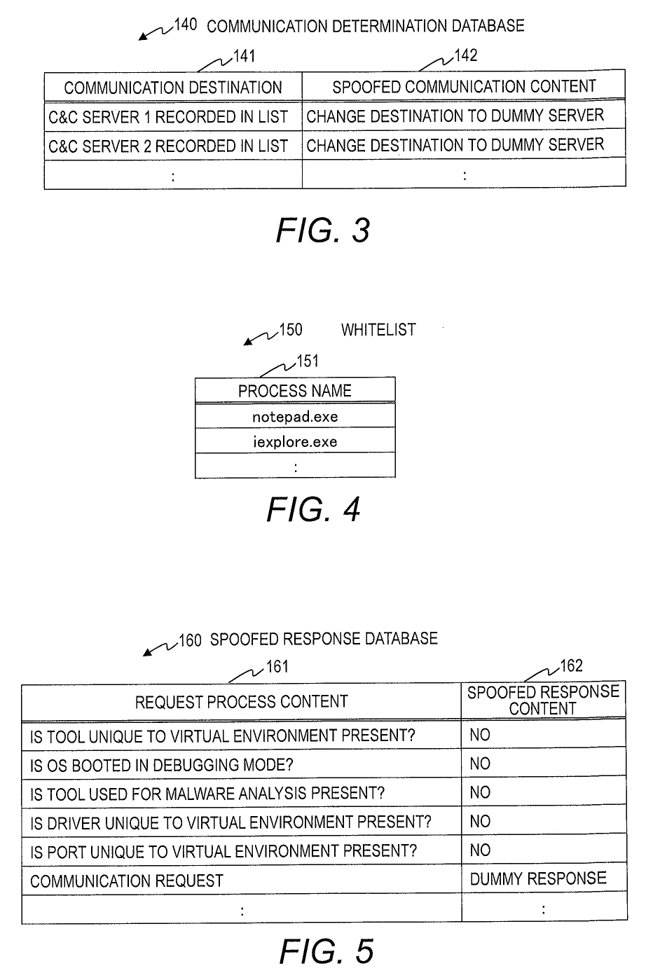

FIG. 3 shows an example of a communication determination database 140 used by the malware dynamic analysis unit 100. The communication determination database 140 includes in each entry a communication destination 141 that stores the communication destination of the malware 210, and spoofed communication content 142 that stores actual processing content.

The communication destination 141 stores lists of C&C servers 50 publicized on the internet, as well as addresses, server names, port numbers, and the like revealed in information, for example. The spoofed communication content 142 stores the address of the dummy server 30 (dummy address) set in advance.

The destination of packets from the malware 210 is not limited to an external computer such as a dummy server 30, and may instead be a prescribed area (such as the virtual machine 14) of the same computer as the host computer 1 on which the malware dynamic analysis unit 100 operates. In such a case, a dummy address is unnecessary, as communication takes place within the same host computer 1.

There may be a plurality of dummy servers 30, and if a plurality of pieces of malware 210 are being monitored in the virtual machine 14, a plurality of dummy servers 30 may be provided. In such a case, communication content can be collected in a different dummy server 30 for each piece of malware 210.

FIG. 4 shows an example of the whitelist 150 used by the malware dynamic analysis unit 100. The whitelist 150 defines in advance the process names 151 of normal applications 220.

The malware dynamic analysis unit 100 can handle as malware 210 applications 200 for which the process names 151 are not defined in the whitelist 150.

FIG. 5 shows an example of the spoofed response database 160 used by the malware dynamic analysis unit 100. The spoofed response database 160 includes, in each entry, request process content 161 that stores content of requests hooked by the response spoofing unit 120 (or the communication spoofing unit 110), and spoofed response content 162 that stores responses to the request process content.

The first entry in the drawing, in which the request process content 161 has an inquiry as to whether a “tool unique to the virtual environment” is present, is used when the malware 210 issues a command to search for or call a tool (application 200) unique to the virtual environment operating on the guest OS 15 of the virtual machine 14. Known tools unique to a virtual environment include “VMWare Tools”, which provides functions such as acquiring snapshots of the guest OS 15, for example.

If the malware 210 discovers such tools unique to virtual environments, it determines that it is operating in a virtual environment, and then stops activities (or deletes itself). Thus, “no” is set as the spoofed response in the spoofed response content 162, and the response spoofing unit 120 is caused to issue this as a response. The malware 210 receives from the guest OS 15 a response that “there are no tools unique to virtual environments” from the response spoofing unit 120, and continues activities.

The second entry in the drawing, in which the request processing content 161 has an inquiry as to whether the “OS is booted in debugging mode”, is used if the malware 210 asks whether the booting mode of the guest OS 15 on the virtual machine 14 is set in debugging mode. The guest OS 15 can boot in debugging mode, and if booted in debugging mode, the malware 210 determines that it is operating in a virtual environment and stops activities (or deletes itself).

Thus, “no” is set as the spoofed response in the spoofed response content 162, and the response spoofing unit 120 is caused to issue this as a response. The malware 210 receives from the guest OS 15 a response that “the booting mode is not debugging mode” from the response spoofing unit 120, and continues activities.

The third entry in the drawing, in which the request process content 161 has an inquiry as to whether a “tool used for analyzing malware” is present, is used when the malware 210 issues a command to search for or call a malware analysis tool operating on the guest OS 15 of the virtual machine 14. Malware analysis tools include publicly known or well-known analysis software such as what is disclosed in Patent Document 1, etc.

If the malware 210 discovers that a malware analysis tool is present, it determines that it is operating in a virtual environment, and then stops activities (or deletes itself). Thus, “no” is set as the spoofed response in the spoofed response content 162, and the response spoofing unit 120 is caused to issue this as a response. The malware 210 receives from the guest OS 15 a response that “there are malware analysis tools” from the response spoofing unit 120, and continues activities.

The fourth entry in the drawing, in which the request process content 161 has an inquiry as to whether a “driver unique to the virtual environment” is present, is used when the malware 210 issues a command to search for or call a driver unique to the virtual environment from among drivers on the guest OS 15 of the virtual machine 14. Known drivers unique to virtual environments include virtual device drivers such as drivers for virtual network adapters (such as VMXNET) or drivers of virtual SCSI adapters (such as PVSCSI).

If the malware 210 discovers such drivers unique to virtual environments, it determines that it is operating in a virtual environment, and then stops activities (or deletes itself). Thus, “no” is set as the spoofed response in the spoofed response content 162, and the response spoofing unit 120 is caused to issue this as a response. The malware 210 receives from the guest OS 15 a response that “there are no drivers unique to virtual environments” from the response spoofing unit 120, and continues activities.

The fifth entry in the drawing, in which the request process content 161 has an inquiry as to whether a “port unique to the virtual environment” is present (open), is used when the malware 210 issues a command to search for or call a port unique to the virtual environment from the guest OS 15 of the virtual machine 14. Ports unique to virtual environments include kernel ports on the hypervisor 17 side for communicating with a virtual management server (not shown). The virtual management server communicates with the hypervisor 17 controlling the virtual computer through the port, and controls the virtual machine 14 on the host computer 1.

If the malware 210 discovers such ports unique to virtual environments, it determines that it is operating in a virtual environment, and then stops activities (or deletes itself). Thus, “no” is set as the spoofed response in the spoofed response content 162, and the response spoofing unit 120 is caused to issue this as a response. The malware 210 receives from the guest OS 15 a response that “there are no ports unique to virtual environments” from the response spoofing unit 120, and continues activities.

The sixth entry in the drawing, where the request process content 161 is “communication request”, is used when the malware 210 communicates with the C&C server 50. Thus, “dummy response” is set as the spoofed response in the spoofed response content 162, and the communication spoofing unit 110 is caused to issue this as a response. As will be described later, the transmission from the malware 210 is forwarded by the communication spoofing unit 110 to the dummy server 30, and thus, ACK packets and the like from the C&C server 50 are spoofed and then issued as a response to the malware 210.

Besides what was described above, there also are examples of the malware 210 that detect virtual environment settings from a registry in the guest OS 15, and thus, for access to entries pertaining to the virtual environment of the registry, the spoofed response content 162 is set to “no”. Additionally, the presence or absence of system services, process names, and the like unique to the virtual environment are also set in the request process content 161, and the spoofed response content 162 is set to “no”.

As described above, the spoofed response database 160 has set therein the request process content 161 and the spoofed response content 162 for when a spoofed response is issued. The request process content 161 includes a request pertaining to the virtual environment, and the spoofed response content 162 has set thereto a spoofed response including that there is no virtual environment. The malware dynamic analysis unit 100 can determine whether or not to issue a spoofed response to a request from the malware 210 by referring to the spoofed response database 160.

The request pertaining to a virtual environment is a request to resources unique to the virtual machines 14, and include a request for searching or calling a tool that functions in a virtual environment as described above, a request for searching or calling drivers in a virtual environment, a request for searching ports used in a virtual environment, and the like.

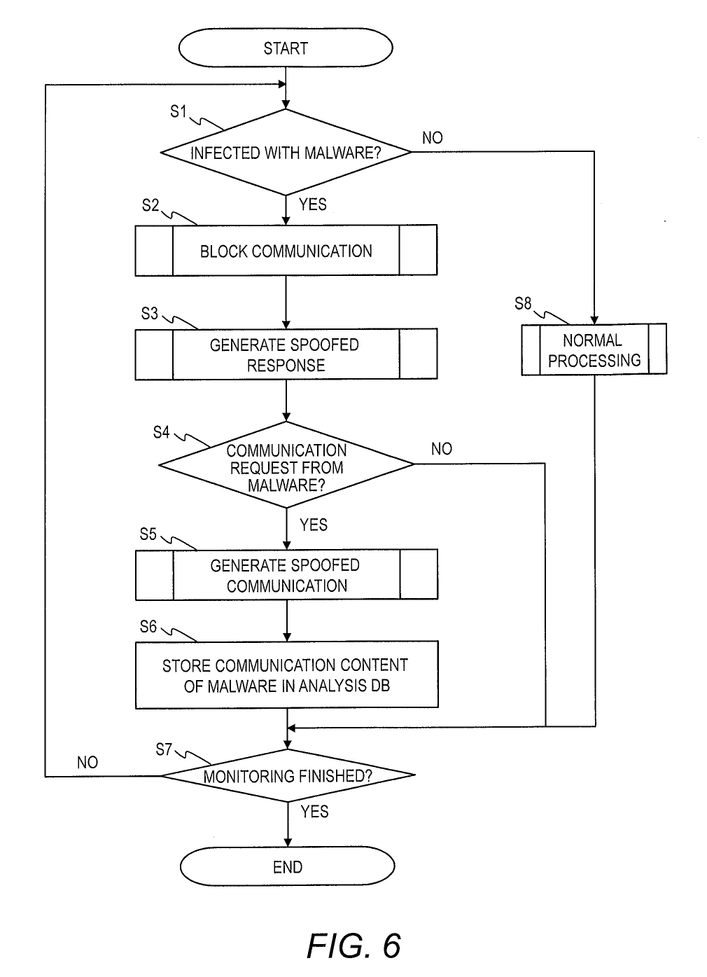

FIG. 6 is a flowchart showing one example of a process performed in a malware dynamic analysis system. This process is started by a user or the like of the virtual machine 14.

First, in step S1, the malware communication blocking unit 130 determines whether the virtual machine is infected by the malware 210. The malware communication blocking unit 130 acquires the process name to be executed on the guest OS 15, and if the process name is not included in the whitelist 150, then the process name is detected as being malware 210.

The malware communication blocking unit 130 determines that the virtual machine 14 is infected by the malware 210, and sets the software with that process name as the malware 210 to be monitored. In the present embodiment, the malware communication blocking unit 130 determines whether the virtual machine is infected by the malware 210, but any configuration may be used as long as the malware 210 is detected.

The malware communication blocking unit 130 progresses to step S2 if it is determined that the virtual machine is infected by the malware 210, and if the virtual machine is not infected, then the malware communication blocking unit progresses to the normal process of step S8. In step S8, the malware dynamic analysis unit 100 hands over requests from the application 200 directly to the guest OS 15 and executes the normal process.

In step S2, the malware communication blocking unit 130 identifies a port number that would be used by the malware 210 for communication and closes the port. In this manner, communication between the malware 210 and the C&C server 50 is blocked.

In step S3, the response spoofing unit 120 receives a request from the application 200, and allows the guest OS 15 to process requests from normal applications 220 as is, while issuing a spoofed response for requests matching a prescribed condition of the spoofed response database 160 for requests from the malware 210. Details of the process of spoofing responses will be described later.

Next, in step S4, the communication spoofing unit 110 determines whether or not the request from the malware 210 is a communication request. If the request from the malware 210 is a communication request, then the process progresses to step S5, and if not, then the process progresses to step S7.

In step S5, the communication spoofing unit 110 switches the communication destination of the malware 210 from the C&C server 50 to the dummy server 30. The communication spoofing unit 110 spoofs the response to the malware 210 in place of the C&C server 50. Details of the process of spoofing communications will be described later.

In step S6, the dummy server 30, in place of the C&C server 50, receives communications from the malware 210 and stores the communication content in the analysis database 40. A user of the malware dynamic analysis system can analyze the behavior of the malware 210 by referring to the analysis database 40 at a prescribed timing.

In step S7, the response spoofing unit 120 determines whether or not a command to stop monitoring has been received from a management server (not shown) or an input device (not shown). If a command to stop monitoring is received, then the process is stopped. On the other hand, if a command to stop monitoring has not been received, then the process returns to step S1, and activities of the malware 210 are monitored, repeating the process above.

By the process above, if the virtual machine is infected by the malware 210, the response spoofing unit 120 can spoof the environment of a physical computer to the malware 210, and the communication content of the malware 210 can be accumulated in the dummy server 30 by the communication spoofing unit 110.

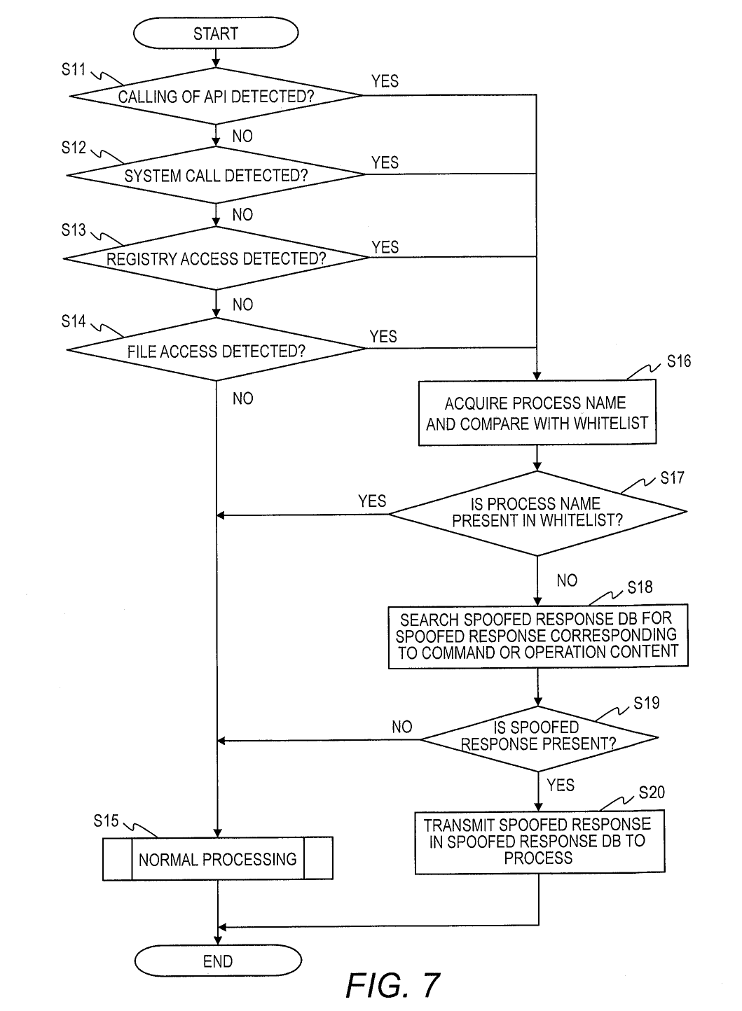

FIG. 7 is a flowchart showing an example of the process performed in the response spoofing unit 120. This process is performed in step S3 in FIG. 6.

First, in step S11, the response spoofing unit 120 determines whether the request received from the application 200 is a command to call an API (application program interface), and if it is a command calling an API, then the process progresses to step S16, and if not, the process progresses to step S12.

In step S12, the response spoofing unit 120 determines whether the request received from the application 200 is a system call, and if it is a system call, then the process progresses to step S16, and if not, the process progresses to step S13.

In step S13, the response spoofing unit 120 determines whether the request received from the application 200 is a request to access a registry, and if it is a request to access a registry, then the process progresses to step S16, and if not, the process progresses to step S14.

In step S14, the response spoofing unit 120 determines whether the request received from the application 200 is a request to access a file, and if it is a request to access a file, then the process progresses to step S16, and if not, the process progresses to step S15.

In step S15, requests received from the application 200 are directly passed onto the guest OS 15 and the normal processing is executed. On the other hand, after step S16, it is determined whether the application 200 is malware 210 or a normal application 220, and the process is switched.

In step S16, the response spoofing unit 120 acquires the process name of the application 200 and compares the process name with the whitelist 150. In step S17, if the current process name is present in the whitelist 150, the response spoofing unit 120 determines that the application is a normal application 220, and executes the normal processing in step S15. On the other hand, if the current process name is not present in the whitelist 150, the response spoofing unit 120 determines that the application is malware 210, and the process progresses to step S18.

In step S18, the response spoofing unit 120 searches the spoofed response database 160 for request process content 161 corresponding to the command or operation from the malware 210. In step S19, the response spoofing unit 120 determines whether request process content 161 corresponding to the received request exists, and if the request process content 161 exists, the process progresses to step S19, and if not, the process progresses to step S15.

In step S19, the response spoofing unit 120 acquires from the spoofed response database 160 the spoofed response content 162 of the request process content 161 corresponding to the received request. The response spoofing unit 120, in place of the guest OS 15, issues as a notification the spoofed response content 162 to the malware 210.

By the process above, when the malware 210 issues a request to the guest OS 15 to call an API, perform a system call, access a registry, access a file, or the like, the response spoofing unit 120 acquires the spoofed response content 162 of the request process content 161 matching the request, and responds to the malware 210 in place of the guest OS 15.

The spoofed response content 162 issues a response indicating that the environment in which the malware 210 is operating is a physical computer environment and not a virtual environment. In this manner, the malware 210 falsely believes that it is operating in a physical computer environment, and communicates with the dummy server 30, which substitutes in for the C&C server 50, enabling activities of the malware 210 to be dynamically analyzed.

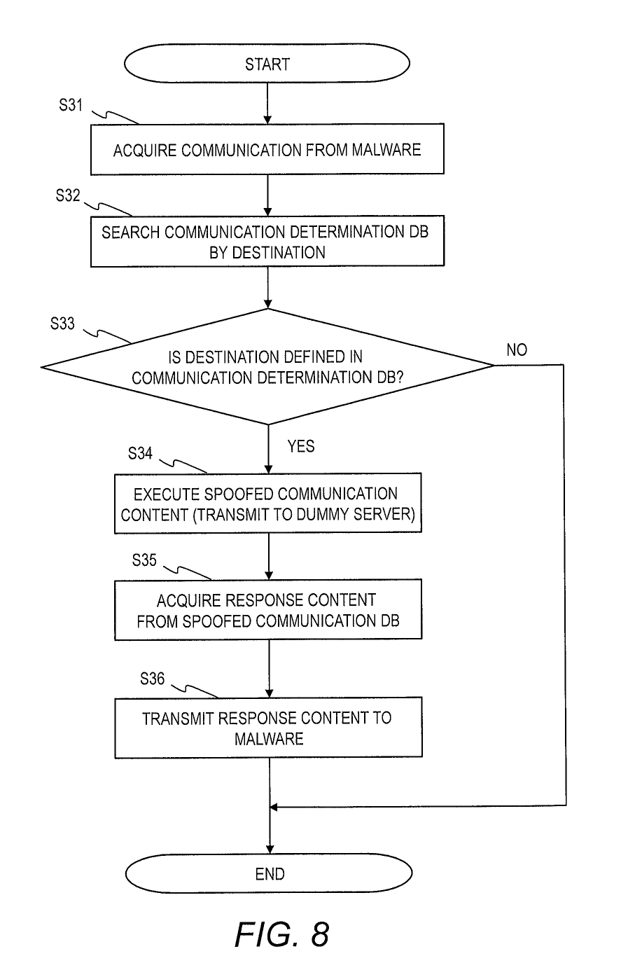

FIG. 8 is a flowchart showing an example of the process performed in the communication spoofing unit 110. This process is performed in step S5 in FIG. 6.

In step S31, the communication spoofing unit 110 acquires the communication content transmitted by the malware 210. In step S32, the destination is selected from the communication content acquired by the communication spoofing unit 110, and searched in the communication determination database 140.

Then, in step S33, the communication spoofing unit 110 determines whether or not the destination of the communication by the malware 210 is defined in the communication determination database 140. If the destination is defined, then the process progresses to step S34, and if the destination is not defined, then the acquired communication content is destroyed and the process is ended.

In step S34, the communication spoofing unit 110 acquires the spoofed communication content 142 corresponding to the destination 141 in the search results from the communication determination database 140, and executes the spoofed communication content 142. In the present embodiment, the communication spoofing unit 110 changes the destination of communication (packets) from the malware 210 to an address of the dummy server 30 and performs communication. Prior to performing communication, the communication spoofing unit 110 issues a request to the malware communication blocking unit 130 for a port to be opened. The malware communication blocking unit 130 opens the port requested by the malware 210 for use.

Next, in step S35, the communication spoofing unit 110 acquires from the spoofed response database 160 the spoofed response content 162 from an entry corresponding to the communication request. In step S36, the communication spoofing unit 110 responds to the malware 210, in place of the C&C server 50, with the acquired spoofed response content 162.

By the process above, when the malware 210 initiates communication with the C&C server 50 or the like, the communication spoofing unit 110 acquires the communication content, which is changed to the spoofed communication content 142 corresponding to the destination 141 of communication in the communication determination database 140. In the present embodiment, data that the malware 210 intended to be transmitted to the C&C server 50 is instead transmitted to the dummy server 30. As a result of the communication spoofing unit 110 acquiring the spoofed response content 162 corresponding to the communication request from the spoofed response database 160 once transmission is complete, and then issuing the spoofed response content as a response to the malware 210, the malware 210 falsely assumes that communication with the C&C server 50 was completed successfully. In this manner, the malware 210 continues its activities, and communication content can be accumulated in the analysis database 40 of the dummy server 30.

### CONCLUSION

As described above, in the present embodiment, by the spoofed response content 162 providing spoofed information to the malware 210 indicating that the malware is operating in a physical computer environment instead of a virtual environment, the malware 210 can be allowed to continue its activities while being dynamically monitored. The communication spoofing unit 110 redirects the communication content issued by the malware 210 from the C&C server 50 to the dummy server 30 and accumulates the communication content in the analysis database 40, thereby allowing activity details of the malware 210 to be accumulated in the virtual environment.

In this manner, in the present embodiment, when the guest OS 15 receives a request from the malware 210 regarding the virtual environment, the response spoofing unit 120 issues a response instead of the guest OS 15 including information indicating that no virtual environment is present, thereby spoofing the response. As a result, it is possible to cause the malware 210 to continue operating in a virtual environment despite being designed to stop operating or delete itself when it detects a virtual environment, and for the malware to be continually monitored.

In the above embodiment, the malware communication blocking unit 130 determines whether the virtual machine is infected by the malware 210, but the malware dynamic analysis unit 100 may determine that the virtual machine is infected by the malware 210 on the basis of the whitelist 150. In such a case, the malware dynamic analysis unit 100 would request the malware communication blocking unit 130 to close the port.

In the above embodiment, an example was illustrated in which infection by the malware 210 is determined using the whitelist 150 of process names, but the configuration is not limited thereto, and a well-known or publicly known technique may be used to detect or determine infection by the malware 210. For example, a technique such as CylancePROTECT that detects malware may be used instead of using a whitelist or a pattern file.

Also, after redirecting the data from the malware 210 to the dummy server 30, the communication spoofing unit 110 may issue a command to the malware communication blocking unit 130 to once again block the port used by the malware 210. In this manner, communication between the malware 210 and the C&C server 50 can be reliably prevented.

Also, in the embodiment above, an example was shown in which the dummy server 30 is a server outside of the host computer 1, but the configuration is not limited thereto, and one of the virtual machines 14 may serve as the dummy server 30.

Additionally, in the embodiment above, the malware dynamic analysis unit 100 and the malware communication blocking unit 130 were disclosed as independent functions (programs), but the configuration is not limited thereto, and the malware dynamic analysis unit 100 may include the malware communication blocking unit 130.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. A malware analysis method for analyzing malware using a virtual computer operating on a physical computer including a processor and memory, the method comprising:
a first step in which an analysis unit operating on a guest OS on the virtual computer acquires a request from the malware to the guest OS; and
a second step in which, if the request from the malware includes a request pertaining to a virtual environment, the analysis unit issues a spoofed response to the malware in response to the request.

2. The malware analysis method according to claim 1, further comprising:
a third step in which, if the request from the malware to the guest OS is a request for communication, the analysis unit changes a destination address for the communication to a dummy address set in advance and then performs communication; and
a fourth step in which the analysis unit issues a response to the malware that the communication is complete.

3. The malware analysis method according to claim 1,
wherein, in the second step, a spoofed response including information that no virtual environment is present is issued to the malware in response to the request.

4. The malware analysis method according to claim 1,
wherein, in the second step, with reference to spoofed response information in which a spoofed response corresponding to the request pertaining to the virtual environment is set in advance, the spoofed response corresponding to the request is issued.

5. The malware analysis method according to claim 4,
wherein the request pertaining to the virtual environment is a request for a resource unique to the virtual computer.

6. The malware analysis method according to claim 5,
wherein the resource unique to the virtual computer is a driver of a virtual device allocated to the virtual computer.

7. The malware analysis method according to claim 5,
wherein the resource unique to the virtual computer is a port of a virtualization unit that controls the virtual computer.

8. The malware analysis method according to claim 1,
wherein the first step includes a step of selecting the request to the guest OS from the malware on the basis of information set in advance, from among requests from applications operating on the virtual computer to the guest OS.

9. The malware analysis method according to claim 1, further comprising:
a third step in which, if the request from the malware to the guest OS is a request for communication, the analysis unit outputs the request to a prescribed area on the physical computer; and
a fourth step in which the analysis unit issues a response to the malware that the communication is complete.

10. A non-transitory computer-readable storage medium that stores programs that control a computer including a processor and memory, the storage medium storing a program that causes the computer to execute:
a first step of acquiring a request from malware to a guest OS; and
a second step in which, if the request from the malware includes a request pertaining to a virtual environment, a spoofed response to the malware is issued in response to the request.

11. The storage medium according to claim 10, the program further comprising:
a third step in which, if the request from the malware to the guest OS is a request for communication, a destination address for the communication is changed to a dummy address set in advance and then communication is performed; and
a fourth step of issuing a response to the malware that the communication is complete.

12. The storage medium according to claim 10,
wherein, in the second step, a spoofed response including information that no virtual environment is present is issued to the malware in response to the request.

13. The storage medium according to claim 10,
wherein, in the second step, with reference to spoofed response information in which a spoofed response corresponding to the request pertaining to the virtual environment is set in advance, the spoofed response corresponding to the request is issued.

14. The storage medium according to claim 13,
wherein the request pertaining to the virtual environment is a request for a resource unique to a virtual computer.

15. The storage medium according to claim 14,
wherein the resource unique to the virtual computer is a driver of a virtual device allocated to the virtual computer.

16. The storage medium according to claim 14,
wherein the resource unique to the virtual computer is a port of a virtualization unit that controls the virtual computer.

17. The storage medium according to claim 10,
wherein the first step includes a step of selecting the request to the guest OS from the malware on the basis of information set in advance, from among requests from applications operating on the virtual computer to the guest OS.

18. The storage medium according to claim 10, the program further comprising:
a third step in which, if the request from the malware to the guest OS is a request for communication, the analysis unit outputs the request to a prescribed area on the physical computer; and
a fourth step in which the analysis unit issues a response to the malware that the communication is complete.
